(19) United States
(12) Patent Application Publication
(10) Pub. No.: US 2023/0182001 A1
(43) Pub. Date: Jun. 15, 2023

(54) Elastic Weaving Toy

(71) Applicant: RGM DESIGN LLC, Elkorn, NE (US)

(72) Inventor: Jennifer EVERETT, Elkhorn, NA (US)

(73) Assignee: RGM DESIGN LLC, Elkorn, NE (US)

(21) Appl. No.: 17/548,585

(22) Filed: Dec. 12, 2021

(51) Int. Cl. A63F 9/06

(52) U.S. Cl. CPC A63F 9/06; A63F 2250/124

(57) ABSTRACT

A geoboard for use as a weaving toy or fidget toy is disclosed. The geoboard includes a board member having a perimeter defining an area. The board member has a top side and a bottom side. The geoboard includes a plurality of projections mounted in a fixed array in the area. The plurality of projections projects perpendicularly from the top side of the board member. The geoboard includes a plurality of elastic bands for engaging at least one of the plurality of projections. The geoboard includes a frame disposed along the perimeter of the board member. At least a portion of each of the plurality of elastic bands are secured between the board member and the frame. Each of the plurality of elastic bands is capable of stretching around any of the plurality of projections in the three rows forming different patterns, or may stretch around only a few projections.

### CROSS-REFERENCE TO RELATED APPLICATIONS

None.

### FIELD OF THE DISCLOSURE

The present invention relates to a toy, and more specifically, to a fidget toy having elastic bands for weaving.

### BACKGROUND OF THE INVENTION

It is known that toys are beneficial for children and adults alike. There is increasing interest in the toys that are fun to use and also are educational, as they aid in developing a person's creativity and intellect. Toys also exist to focus the tendency to fidget, on a particular object/toy. For example, fidget-spinners have become very popular recently, which focus a child's fidgeting proclivities on a particular object capable of spinning. Several other toys exist in the art that aid in a person's creativity, intellect, and focus on fidgeting. One such toy is a geoboard. The geoboard includes a board with elastic bands or strings. The geoboard involves use of the elastic bands to make different patterns.

Several toys, such as geoboards, have been disclosed in the past. One such example is disclosed in a United States granted U.S. Pat. No. 5,639,090, entitled “Geoboard with movable pins” (“the '090 patent”). The '090 patent discloses a geoboard having a board member with four edges. An array of holes, which is preferably in the form of a matrix, is provided in the board member for receiving slidably mounted push-up pins. Each push-up pin has upper and lower positions, and the pins are arranged in the matrix for engagement by an elastic band to form shapes on the board member. Each of the edges includes spaced-apart notches for receiving fixed slider pins which extend in a row on a slider. Each slider is slidably mounted along one of the edges for extending the matrix of push-up pins.

Another example is disclosed in a United States granted U.S. Pat. No. 6,213,918, entitled “Method and apparatus for finger, hand and wrist therapy” (“the '918 patent”). The '918 patent discloses a method and an apparatus to strengthen an individual's hands, fingers and wrists. The apparatus includes at least one resilient band supported by at least one of a plurality of spaced pegs which extend from at least one side of a support base and wherein resistance of the at least one resilient band to manipulation by the fingers and hands is used to exercise and strengthen muscles of the hands and wrists.

Although other devices or toys are useful in their design and form, they have a few limitations. For example, certain elastic bands are removed from the board or pins and reconnected to create a new pattern. In other words, the elastic bands are removable and are not connected to the board. As a result, the elastic bands can get lost.

Therefore, there remains a continuing need for improved toy design that would be advantageous to enhance the creativity and intellect of the player, the toy that allows to form different weaving patterns without having to remove any part of the toy i.e., the elastic bands, the pins and the board to create the new designs or patterns.

### BRIEF SUMMARY OF THE PRESENT INVENTION

The present invention provides a geoboard for use as a weaving toy or fidget toy. The geoboard includes a board member having a perimeter defining an area. The board member has a top side and a bottom side. The board member is rectangular shaped having a first edge and an opposing second edge, and a third edge and an opposing fourth edge. The geoboard includes a plurality of projections mounted in a fixed array in the area. The plurality of projections projects perpendicularly from the top side of the board member. The geoboard includes a plurality of elastic bands for engaging at least one of the plurality of projections. At least one of the plurality of elastic bands is secured across the board member at the first edge and the second edge. Further, at least one of the plurality of elastic bands is secured across the board member the third edge and the fourth edge. The geoboard includes a frame disposed along the perimeter of the board member. At least a portion of each of the plurality of elastic bands are secured between the board member and the frame.

In one aspect of the present invention, the plurality of projections is arranged in at least three rows. The plurality of elastic bands is stretched or weaved around any of the plurality of projections in the at least three rows to form a variety of designs or patterns with the plurality of elastic bands.

In one advantageous feature of the present invention, the elastic bands are secured between the frame and the board member. As such, the elastic bands are not removable and cannot get lost. Further, all the parts such as elastic bands, projections, and frame are secured to the board member ensuring that there is no need to remove any part of the geoboard. Whenever needed, the user can quickly start weaving the elastic bands to form different patterns.

In another aspect of the present invention, there is a method of providing a geoboard. The method includes the steps of providing a board member having a perimeter defining an area, the board member having a top side and a bottom side. The method further includes providing a plurality of projections in a fixed array in the area, the plurality of projections projecting perpendicularly form the top side of the board member. The method further includes the step of providing a plurality of elastic bands for engaging at least one of the plurality of projections. The method further includes the step of providing a frame disposed along the perimeter of the board member. The method further includes the step of securing at least a proportion of each of the plurality of elastic bands between the board member and the frame.

In another advantageous feature of the present invention, the geoboard can be used as a weaving toy or fidget toy, boosting focus and stimulating learning and creativity.

### BRIEF DESCRIPTION OF THE DRAWINGS

FIG. 1 shows an environment in which a geoboard is being operated by a user, in accordance with one exemplary embodiment of the present invention;

FIG. 2 is a perspective view of a board member having projections, in accordance with one embodiment of the present invention;

FIG. 3 is a perspective view of the board member having the projections and elastic members, in accordance with one embodiment of the present invention;

FIG. 4 is a front view of the geoboard having a frame at the perimeter of the board member, in accordance with one embodiment of the present invention; and

FIG. 5 is a front view of the geoboard in use, in accordance with one exemplary embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this application are hereby incorporated by reference in their entireties.

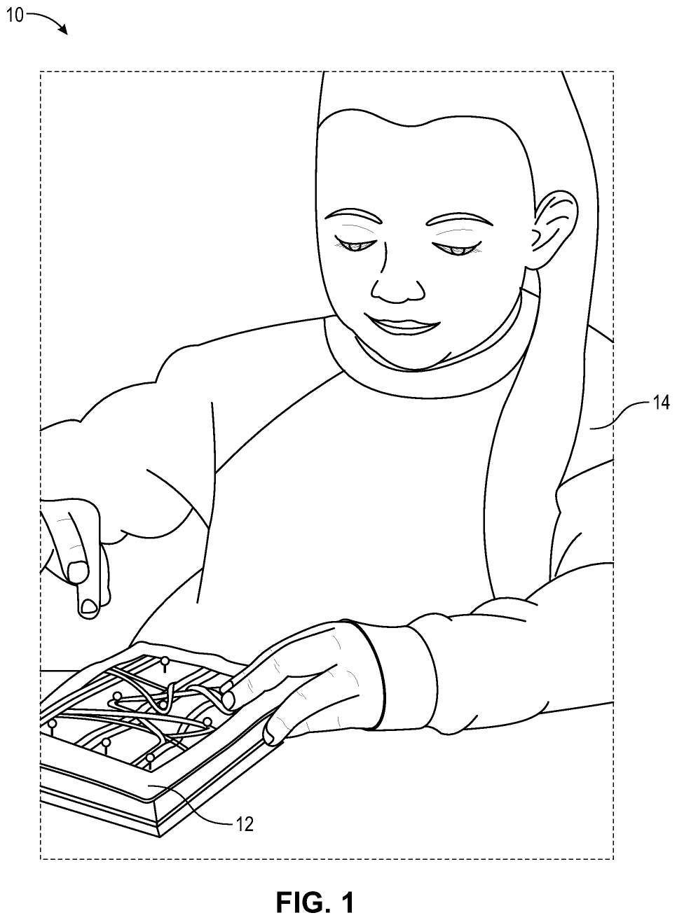

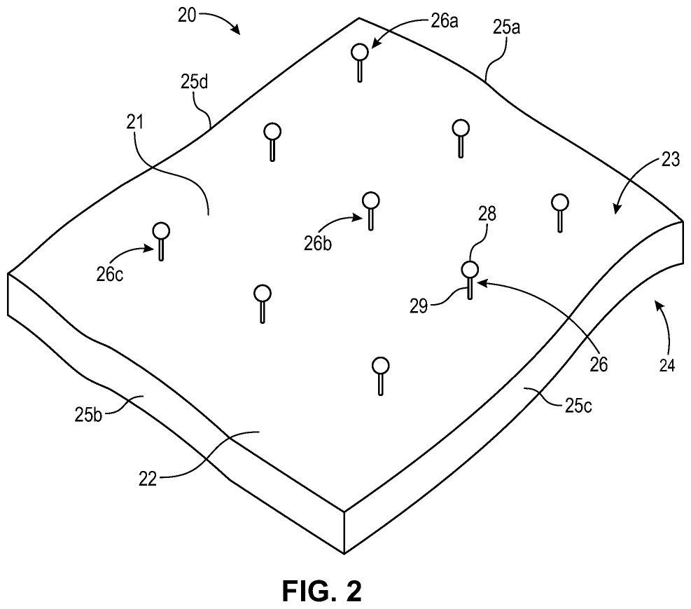

Turning to the Figures, FIG. 1 shows an environment 10 in which geoboard 12 is being operated by user 14, in accordance with one exemplary embodiment of the present invention. In the present invention, geoboard 12 is used as a weaving toy or fidget toy for boosting focus and stimulating learning and creativity of user 14. User 14 includes a child or adult. Geoboard 12 presents board member 20 (shown in FIG. 2).

FIG. 2 shows a perspective view of board member 20, in accordance with one embodiment of the present invention. Board member 20 comes in a variety of shapes and sizes. In one example, board member 20 comes in a rectangular configuration. In a preferred example, the board may be about 9 inches by 9 inches (about 23 cm by 23 cm). In another example, board member 20 comes in a circular configuration. A person skilled in the art understands that it is possible to provide board member 20 in any shape without departing from the scope of the present invention by varying in size of dimensions by 10%, 25%, 50%, 75%, 90%, or any value in between or in excess of these dimensions. Board member 20 provides a material made of metal, plastic, wood, fabric, or any other suitable material. Board member 20 encompasses an area 21 having perimeter 22. Further, board member 20 presents first end 23 and second end 24. First end 23 indicates a top surface or top side of board member 20 and second end 24 indicates a bottom surface or bottom side of board member 20.

Board member 20 encompasses four edges at each side i.e., at perimeter 22. Specifically, board member 20 encompasses first edge 25a, second edge 25b, third edge 25c and fourth edge 25d. Second edge 25b positions at the opposite side of first side 25a. Third edge 25c and fourth edge 25d position perpendicularly to edge 25a and second edge 25b. As can be seen, third edge 25c positions at the opposite side of fourth edge 25d.

Board member 20 includes a plurality of projections 26 disposed at first end 23. Plurality of projections 26 positions in area 21 and projects upward from first end 23 of board member 20. Plurality of projections 26 includes, but not limited to, hooks, pins, pegs, magnetic members, retaining means, etc. In one example, plurality of projections 26 are arranged in at least two or three rows. In another example, plurality of projections 26 are arranged in the form of a matrix of various configurations. The matrix includes 3×3, 4×4, 5×5 or any other array projections 26, which may or may not be linear. Considering an embodiment where plurality of projections 26 are arranged in three rows, projections 26 positioned in the first row are referred as first projections 26a, projections 26 positioned in the second row are referred as second projections 26b and projections 26 positioned in the third row are referred as third projections 26c. Each of projections 26 includes head 28 and shaft 29. Here, shaft 29 inserts in board member 20. Head 28 helps to retain elastic bands 30, 6 when secured to respective projections 26. In one example, projections 26 mount fixedly to board member 20 at first end 23. In another example, projections 26 e.g., magnetic members removably mount to board member 20 at first end 23.

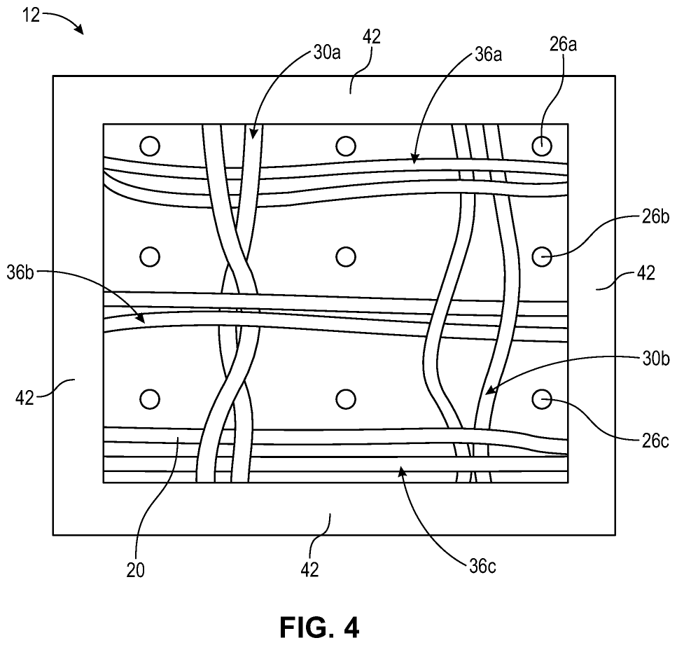

Further, geoboard 12 includes a plurality of parallel and perpendicular elastic bands (or substantially parallel and substantially perpendicular elastic bands). These elastic bands may be presented in pairs or without pairing to other nearby or adjacent bands. The bands may be stretched in ways that make them no longer parallel or perpendicular to each other (as shown in FIG. 4). To distinguish the relative position of the bands to each other, the bands are herein described as vertical elastic bands 30 and horizontal elastic bands 36, which are perpendicular to each other. The terms vertical and horizontal merely denote relative positioning to each other. For ease of reference (as shown in FIG. 4), the vertical bands are shown as going up and down, and the horizontal bands are going side to side. It is noted that should the geoboard 12 be reoriented, what is considered vertical and horizontal may be reversed, or if the board is placed on a flat surface, the bands would have no vertical orientation with respect to the ground, but the bands would still be parallel and perpendicular to each other. Vertical elastic bands 30 include, but not limited to, elastic members, rubber bands, strings, etc. In one example, each of the vertical elastic bands 30 includes a loop of flexible material. In another example, each or pair of vertical elastic bands 30 includes elastic non-looped strings.

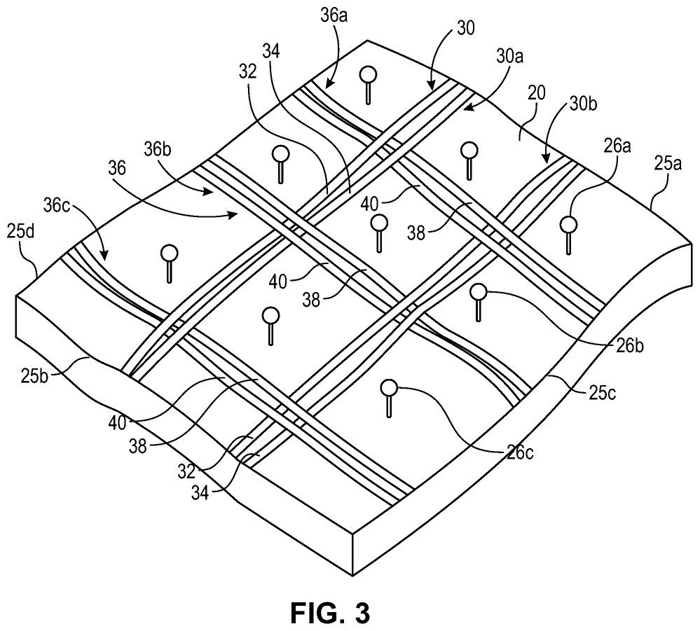

In the present embodiment, the plurality of vertical elastic bands 30 extend the entire length of board member 20 and connect to board member 20 at first edge 25a and second edge 25b. The plurality of vertical elastic bands 30 connect to board member 20 at first edge 25a and second edge 25b using adhesive, fastener, or any other connecting mechanism. The plurality of vertical elastic bands 30 are placed at equal or varied distance from one another. In one example, the plurality of vertical elastic bands 30 includes two pairs of vertical elastic bands 30 placed at equal distance from one another, as shown in FIG. 3. Considering the plurality of vertical elastic bands 30 are arranged in two rows, pair of vertical elastic bands 30 positioned in the first row is referred as first pair of vertical elastic bands 30a and the pair of vertical elastic bands 30 positioned in the second row is referred as second pair of vertical elastic bands 30b. As can be seen, each of first pair of vertical elastic bands 30a and second pair of vertical elastic bands 30b extend from first edge 25a and second edge 25b and position in between adjacent projections 26. Each pair of vertical elastic bands 30 includes first vertical elastic band 32 and second vertical elastic band 34. Each of first vertical elastic band 32 and second vertical elastic band 34 extends and connects to any of projections 26 to form a design or pattern depending on the need. The elastic bands 30 are capable of stretching around nay of the plurality of projections 26 from a variety of the rows.

Geoboard 12 includes plurality of horizontal elastic bands 36 (and may be a plurality of pairs of horizontal bands or a plurality of unpaired horizontal bands). The plurality of horizontal elastic bands 36 extend the entire length of board member 20 and connect to board member 20 at third edge 25c and fourth edge 25d. The plurality of horizontal elastic bands 36 connect to board member 20 at third edge 25c and fourth edge 25d using adhesive, fastener, or any other connecting mechanism. The plurality of horizontal elastic bands 36 are placed at equal or varied distance from one another. In one example, the plurality of horizontal elastic bands 36 includes three pairs of horizontal elastic bands 36 placed at equal distance from one another, as shown in FIG. 3. Considering the plurality of horizontal elastic bands 36 are arranged in three rows, the horizontal elastic bands 36 positioned in the first row is referred as first pair of horizontal elastic bands 36a, pair of horizontal elastic bands 36 positioned in the second row is referred as second pair of horizontal elastic bands 36b and pair of horizontal elastic bands 36 positioned in the third row is referred as third pair of horizontal elastic bands 36c. Each of first pair of horizontal elastic bands 36a, second pair of horizontal elastic bands 36b and third pair of horizontal elastic bands 36c position perpendicular to first pair of vertical elastic bands 30a and second pair of vertical elastic bands 30b. Further, first pair of horizontal elastic bands 36a positions between first projections 26a and second projections 26b. Second pair of horizontal elastic bands 36b positions in between second projections 26b and third projections 26c. Third pair of horizontal elastic bands 36c positions between third projections 26c and fourth edge 25d of board member 20.

As can be seen, each of first pair of horizontal elastic bands 36a, the second pair of horizontal elastic bands 36b and the third pair of horizontal elastic bands 36c intersect and position above or below the first pair of vertical elastic bands 30a and the second pair of vertical elastic bands 30b. In one embodiment, the first pair of horizontal elastic bands 36a, second pair of horizontal elastic bands 36b and third pair of horizontal elastic bands 36c intersect in a weave form. Each pair of horizontal elastic bands 36 includes first horizontal elastic member 38 and second vertical elastic member 40. Each of the first horizontal elastic member 38 and second vertical elastic member 40 extends and connects to any of projections 26 to form a design or pattern depending on the need.

Further, geoboard 12 includes frame 42 disposed along perimeter 22 of board member 20 at its first end 23. In one example, frame 42 comes in a rectangular shape. In another example, frame 42 comes in the shape of perimeter 22 of board member 20. In one example, frame 42 has a width of at least one centimeter or inch depending on the need. As specified above, elastic bands 30, 36 connect board member 20 at perimeter 22 or edges 25a, 25b, 25c and 25d. In accordance with the present invention, frame 42 connects to board member 20 in a way that a portion of elastic bands 30, 36 are secured between frame 42 and board member 20. FIG. 4 shows a front view of geoboard 12 showing elastic bands 30, 36 disposed over board member 20 connecting frame 42. As portions of elastic bands 30;36 are secured between frame 42 and board member 20, it is ensured that elastic bands 30;36 do not get lost.

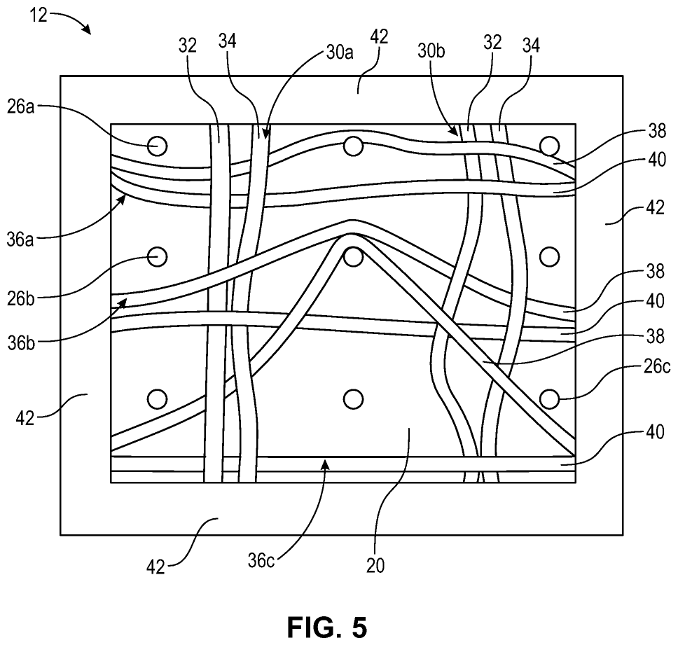

FIG. 5 shows a perspective view of geoboard 12 in use or operation, in accordance with one exemplary embodiment of the present invention. In the present embodiment, first horizontal elastic member 38 of third pair of horizontal elastic bands 36c stretches or extends and secures to second projections 26b i.e., middle projection 26 in second row. Here, first horizontal elastic member 38 and second horizontal elastic member 40 of third pair of horizontal elastic bands 36c form a triangular shape. Similarly, user 14 extends first vertical elastic band 32 and second vertical elastic band 34 of first pair of vertical elastic bands 30a and second pair of vertical elastic bands 30b, and first horizontal elastic member 38 of third pair of horizontal elastic bands 36c of first pair of horizontal elastic bands 36a, second pair of horizontal elastic bands 36b and third pair of horizontal elastic bands 36c either alone in combination and secures to any projections 26 on board member 20 forming a design or pattern. A person skilled in the art understands that user 14 connects elastic bands 30, 36 to any of projections 26a, 26b, 26c forming various patterns using his/her creativity and intellect. The design or pattern includes, but not limited to, a triangle, square, rectangular, polygons, flower, alphabets, numerals, cartoon characters, or any other shape/pattern. In one example, elastic bands 30, 36 come in different colors or sizes to enhance the entertainment value of geoboard 12.

Again, while the elastic bands are described above and shown in the drawings as being in parallel pairs, no specific pairing is required. The bands can be unpaired without detracting from the spirit of the invention, because either paired or unpaired bands are still capable of being stretched over projections 26 to form different designs on the geoboard 12.

Embodiments also includes a method of providing and using a geoboard 12 having the features described above.

The embodiments provide for several advantages over the prior art. For example, the presently disclosed geoboard allows the user to play with it for fun and also be used as an educational toy such as a fidget toy or weaving toy. The user can weave the elastic bands to form different designs and enhance the entertainment value of the geoboard. In the presently disclosed geoboard, the elastic bands are secured between the frame and the board member. As such, the elastic bands are not removable and cannot get lost. Furthermore, all the parts such as elastic bands, projections, and frame are secured to the board member ensuring that there is no need to remove any part of the geoboard. Whenever needed, the user can quickly start weaving the elastic bands to form different patterns.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A geoboard, comprising:
a board member having a perimeter defining an area, wherein the board member has a top side and a bottom side;
a plurality of projections mounted in a fixed array in the area, wherein the plurality of projections project perpendicularly from the top side of the board member;
a plurality of elastic bands for engaging at least one of the plurality of projections and forming a pattern; and,
a frame disposed along the perimeter of the board member, wherein at least a portion of each of the plurality of elastic bands are secured between the board member and the frame.

2. The geoboard of claim 1, wherein the plurality of elastic bands are loops.

3. The geoboard of claim 1, wherein the plurality of elastic bands are elastic non-looped strings.

4. The geoboard of claim 1, wherein the plurality of projections forms a matrix of projections.

5. The geoboard of claim 1, wherein the plurality of projections are fixedly mounted to the board member.

6. The geoboard of claim 1, wherein the plurality of projections removably mount to the board member.

7. The geoboard of claim 1, wherein the projections include one of pegs, pins, hooks, magnetic members, and retaining means.

8. The geoboard of claim 1, wherein the board member is rectangular shaped having a first edge and an opposing second edge, and a third edge and an opposing fourth edge.

9. The geoboard of claim 8, wherein at least one of the plurality of elastic bands is secured across the board member at the first edge and the opposing second edge, and wherein at least one of the plurality of elastic bands is secured across the board member the third edge and the fourth edge.

10. The geoboard of claim 1, wherein the frame is a rectangular frame.

11. The geoboard of claim 1, wherein the plurality of projections is arranged in at least three rows.

12. The geoboard of claim 11, wherein each of the plurality of elastic bands is capable of stretching around any of the plurality of projections in the at least three rows.

13. A method of providing a geoboard, the method comprising steps of:
providing a board member having a perimeter defining an area, the board member having a top side and a bottom side;
providing a plurality of projections in a fixed array in the area, the plurality of projections projecting perpendicularly from the top side of the board member;
providing a plurality of elastic bands for engaging at least one of the plurality of projections;
providing a frame disposed along the perimeter of the board member; and
securing at least a portion of each of the plurality of elastic bands between the board member and the frame.

14. The method of claim 13, further comprising forming a pattern using the plurality of elastic bands when engaged with at least one of the plurality of projections.

15. The method of claim 13, further comprising forming a matrix of projections with the plurality of projections.

16. The method of claim 13, further comprising securing the plurality of projections fixedly to the board member.

17. The method of claim 13, further comprising providing the board member in a rectangular configuration having a first edge and an opposing second edge, and a third edge and an opposing fourth edge.

18. The method of claim 17, further comprising securing at least one of the plurality of elastic bands across the board member at the first edge and the second edge, and securing at least one of the plurality of elastic bands across the board member at the third edge and the fourth edge.

19. The method of claim 13, further comprising arranging the plurality of projections in at least three rows.

20. The method of claim 19, further comprising stretching each of the plurality of elastic bands around any of the plurality of projections in the at least three rows.
